(19) United States
(12) Patent Application Publication
(10) Pub. No.: US 2026/0201153 A1
(43) Pub. Date: Jul. 16, 2026

(54) Polyolefin Composition Comprising Polyethylene and Recycled Plastic Material

(71) Applicant: Borealis AG, Vienna (AT)

(72) Inventors: Yi Liu, Linz (AT); Paul Johann Freud, Linz (AT); Jörg Fischer, Linz (AT); Reinhold W. Lang, Linz (AT)

(21) Appl. No.: 19/136,309

(22) PCT Filed: Dec. 6, 2023
(86) PCT No.: PCT/EP2023/084427

§ 371 Date: Jun. 6, 2025

(30) Foreign Application Priority Data
Dec. 7, 2022 (EP) 22211948.9

(51) Int. Cl. C08L 23/06; C08J 3/20; C08K 5/00

(52) U.S. Cl. CPC C08L 23/06; C08J 3/203; C08K 5/005; C08J 2323/06; C08J 2423/06; C08J 2423/08; C08L 2203/10; C08L 2205/025; C08L 2205/03; C08L 2207/062; C08L 2207/20

(57) ABSTRACT

Provided is a polyolefin composition including 20-65 wt % of at least one high density polyethylene including at least one polyethylene homopolymer and at least one polyethylene copolymer with a melt flow rate MFR₅ (190° C., 5 kg, measured according to ISO 1133) of at least 0.8 g/10 min and a B10 ESCR above 600 hours (measured according to ASTM D1693); 35-80 wt % of a polyethylene enriched blend of recycled plastic material, with a C2 fraction in amount of above 96.5 wt. %, as measured by NMR of the d2-tetrachloroethylene soluble fraction, and a continuous C3 fraction in amount of ≤3.5 wt.-%, as measured by NMR of the d2-tetrachloroethylene soluble fraction; optionally further additives, wherein the sum of all ingredients always adds up to 100 wt %. The polyolefin composition has an impact strength (ISO179-1, Charpy 1eA+23° C.) of at least 25 kJ/m².

### CROSS-REFERENCE TO A RELATED APPLICATIONS

This application is the United States national phase of International Patent Application No. PCT/EP2023/084427 filed Dec. 6, 2023, and claims priority to European Patent Application No. 22 211 948.9, filed on Dec. 7, 2022, the disclosures of each of which are hereby incorporated by reference in their entireties.

### BACKGROUND

### Technical Field

The present disclosure relates to a polyolefin composition comprising at least one bimodal polyethylene and recycled plastic material, to an article comprising the polyolefin composition and a process for preparing such a polyolefin composition.

Technical Considerations Polyolefins, such as polyethylene and polypropylene are increasingly consumed in large amounts in a wide range of applications, including packaging for food and other goods, fibres, automotive components, and a great variety of manufactured articles. Taking into account the huge amount of waste collected compared to the amount of waste recycled back into the stream, there is still a great potential for intelligent reuse of plastic waste streams and for mechanical recycling of plastic wastes.

With their inherent versatility, plastics play crucial roles in a sustainable and resource-efficient economy. However, as more and more plastic has been created and used in a mode of linear economy, plastic waste is nowadays considered a serious social problem. For that, it is important to form a circular economy that brings plastic waste back to a second life, i.e., to recycle it. This not only avoids leaving plastic waste in the environment but also recovers its value.

The European Commission confirmed in 2017 that it would focus on plastics production and use. According to Packaging and Packaging Waste Directive (amended in 2018), the EU goals are that 1) by 2025 at least 50% of all plastics packaging in the EU should be recycled and 2) by 2030 all plastic packaging placed in the EU market is reusable or easily recycled. This pushes the brand owners and plastic converters to pursue solutions with recyclate or virgin/recyclate blends. On 1 Jan. 2021, EU introduced a new levy on non-recycled plastic packaging, which is calculated on the weight of non-recycled plastic packaging at €0.80/kg

It is therefore urgently needed to find ways of recycling plastic waste. However, recycled plastics are normally inferior to virgin plastics in their quality due to degradation, contamination and mixing of different plastics.

One major trend in the field of polyolefins is the use of recycled materials, which are derived from a wide variety of sources. Durable goods streams such as those derived from yellow bags, yellow bins, community collections, waste electrical equipment (WEE) or end-of-life vehicles (ELV) contain a wide variety of plastics. These materials can be processed to recover acrylonitrile-butadiene-styrene (ABS), high impact polystyrene (HIPS), polypropylene (PP) and polyethylene (PE) plastics. Separation can be carried out using density separation in water and then further separation based on fluorescence, near infrared absorption or raman fluorescence.

Among the plastic waste, polyethylene is one of the most abundant as it is widely used in packaging, building and piping industry Recycled polyethylene is mainly made of goods such as bottles and packaging, which are sorted, chopped, washed and homogenized to provide a material for different applications. Although recycled polyethylene is already used for low-pressure pipes for gardens and agriculture, other applications such as high pressure pipes are more restricted due to the higher requirements.

Different approaches for useful applications of recycled polyethylene have been described.

WO 2021/074785 A1 describes a polyethylene blend comprising: from 1 wt. % to 50 wt. % recycled polyethylene; and from 50 wt. % to 99 wt. % of a bimodal polyethylene composition. The bimodal polyethylene composition is composed of a least two ethylene copolymer components; a first ethylene copolymer and a second ethylene copolymer.

WO2021/74698 A1 refers to a blow molded article incorporating post-consumer recyclate. The article may comprise a blended ethylene-based polymer composition, the blended ethylene-based having a post-consumer resin (PCR) content varying from greater than 10 wt % to less than 95 wt % and a virgin resin content varying from greater than 5 to less than 90 wt %, wherein the virgin resin is selected from HDPE, LLDPE, LDPE, EVA, or combinations thereof. The PCR is preferably a HDPE PCR obtained from blow molded articles such as lubricant oil bottles. Often, such PCR may have a high amount of HDPE, though with the recycling process impurities may be present and the material source may include LLDPE and/or LDPE. Thus, the PCR may be a mixture of polyethylenes, but is commonly predominantly HDPE.

WO2021/074140 A1 refers to a polyethylene composition comprising a polyethylene, preferably ≥95.0 wt % of polyethylene, and further 100-500 ppm of a phenolic antioxidant; 500-2500 ppm of an organic phosphite stabiliser; and 500-2500 ppm of a metal stearate with regard to the total weight of the polyethylene composition.

As one can see, the use of recycled polyethylene for replacing virgin polyethylene is in general possible. However, there is still a need for improving or maintaining thermomechanical properties such as impact strength or environmental stress crack resistance (ESCR) when replacing virgin polymer by recycled material.

### SUMMARY

Thus, it is an object the present disclosure to provide a polyolefin composition wherein at least a part of virgin polyolefin is replaced by polyolefin material recovered from waste plastic material while thermomechanical properties of such a polyolefin composition are at least maintained or even improved.

This object has been solved by providing a polyolefin composition comprising:
a) 20-65 wt % (based on the total weight of the polyolefin composition) of at least one high density polyethylene comprising at least one polyethylene homopolymer and at least one polyethylene copolymer with a melt flow rate MFR₅ (190′C, 5 kg, measured according to ISO 1133) of at least 0.8 g/10 min and a B10 ESCR above 600 hours (measured according to ASTM D1693 at condition B in 10% Igepal at 50′C);
b) 35-80 wt % (based on the total weight of the polyolefin composition) of a polyethylene enriched blend of recycled plastic material, which is recovered from a waste plastic material derived from post-consumer and/or post-industrial waste, with
   a C2 fraction in an amount of above 96.5 wt. %, for example in a range of 96.5 to 99.9 wt %, as measured by NMR of the d2-tetrachloroethylene soluble fraction, and
   a continuous C3 fraction in an amount of s 3.5 wt.-%, for example in the range from 0.1 to 3.5 wt %, as measured by NMR of the d2-tetrachloroethylene soluble fraction;
c) optionally further additives, wherein the sum of all ingredients always adds up to 100 wt %.
   wherein the polyolefin composition has an impact strength (IS0179-1, Charpy 1eA+23′C) of at least 25 kJ/m².

Thus, a polyolefin composition is provided that comprises recycled plastic material and virgin high density polyethylene polymer, for example bimodal polyethylene polymer comprising a polyethylene homopolymer and a polyethylene copolymer with a low melt flow rate and a high environmental stress crack resistance (ESCR). This combination provides a composition wherein at least a part of virgin polymer is replaced by recycled material, wherein properties such as impact strength as well as melt flow rate and environmental stress crack resistance (ESCR) are almost comparable to the virgin polymers. Such compositions are applicable for bottles and containers, for example.

In the context of this disclosure, the term “C2 fraction” stands for the total amount of ethylene units determined by NMR in the d2-tetrachloroethylene soluble fraction of the polyethylene enriched blend of recycled plastic material.

The term “continuous C3 fraction” stands for the total amount of continuous units having 3 carbon atoms corresponding to polypropylene (continuous C3 units).

As described, the polyolefin composition according to the present disclosure comprises a polyethylene enriched blend of recycled plastic material with a high C2 content and low isotactic polypropylene (iPP) fraction (i.e., low continuous C3 content). It was surprisingly found that the purity of the polyethylene recyclate has a profound effect on the impact strength of the polyolefin composition at high content (≥35%) of the recyclate. The polyolefin composition prepared with a PE recyclate of high purity have considerably higher impact strength than the compounds prepared from PE recyclates of lower purity, even though the difference in impact strength among those recyclates is not pronounced.

It is to be understood that the present polyolefin composition does not comprise talc (except any amounts present in the recyclate) and rubber.

For the purposes of the present disclosure, the term “recycled” is used to indicate that the material is recovered from post-consumer waste and/or industrial waste. Namely, post-consumer waste refers to objects having completed at least a first use cycle (or life cycle), i.e., having already served their first purpose and been through the hands of a consumer; while industrial waste refers to the manufacturing scrap which does normally not reach a consumer.

As described also further below, typical other components originating from the first use are thermoplastic polymers, like polystyrene and polyamide, talc, chalk, carbon black, pigments, such as TiO₂, ink, wood, paper, cellulose, limonene and/or fatty acids. The content of polystyrene (PS) and polyamide (PA) in recycled polymers can be assessed by Fourier Transform Infrared Spectroscopy (FTIR) and the content of talc, chalk and carbon black, may be measured by Thermogravimetric Analysis (TGA).

The term “virgin” denotes the newly produced materials and/or objects prior to first use and not being recycled. In case that the origin of the polymer is not explicitly mentioned the polymer is a “virgin” polymer.

According to some non-limiting embodiments, the present polyolefin composition comprises:
a) 30-60 wt %, preferably 35-55 wt %, more preferably 40-50 wt % (based on the total weight of the polyolefin composition) of the at least one high density polyethylene with a melt flow rate MFR₅ (190′C, 5 kg, measured according to ISO 1133) of at least 0.8 g/10 min and a B10 ESCR above 600 hours (measured according to ASTM D1693 at condition B in 10% Igepal at 50′C);
b) 40-70 wt %, preferably 45-65 wt %, more preferably 50-60 wt % (based on the total weight of the polyolefin composition) of the polyethylene enriched blend of recycled plastic material, which is recovered from a waste plastic material derived from post-consumer and/or post-industrial waste, and
c) optionally further additives, wherein the sum of all ingredients always adds up to 100 wt %.

It is to be understood that the amounts of virgin, high density polyethylene and polyethylene recyclate are always complementary to each other in the polymeric composition. For example, the polymeric composition may comprise in some non-limiting embodiments 20 wt % virgin, high density polyethylene and 80 wt % polyethylene recyclate or vice versa, or 30 wt % virgin, high density and 70 wt % polyethylene recyclate or vice versa. It is to be understood that additives may be present. In such a case, the amount of virgin polyethylene and polyethylene recyclate may be slightly less, but the weight ratio still corresponds essentially to the wt % as indicated.

In some non-limiting embodiments, the present polyolefin composition may comprise:
20 wt % virgin, high density polyethylene and 80 wt % polyethylene recyclate;
30 wt % virgin, high density polyethylene and 70 wt % polyethylene recyclate;
35 wt % virgin, high density polyethylene and 65 wt % polyethylene recyclate;
40 wt % virgin, high density polyethylene and 60 wt % polyethylene recyclate;
45 wt % virgin, high density polyethylene and 55 wt % polyethylene recyclate;
50 wt % virgin, high density polyethylene and 50 wt % polyethylene recyclate;
55 wt % virgin, high density polyethylene and 45 wt % polyethylene recyclate;
60 wt % virgin, high density polyethylene and 40 wt % polyethylene recyclate; or
65 wt % virgin, high density polyethylene and 35 wt % polyethylene recyclate.

In some non-limiting embodiments, the polyolefin composition comprises at least one stabilizer, for example at least one anti-oxidant agent. The at least one stabilizer may be present in the polyolefin composition in an amount of 0.05-0.5 wt %, preferably of 0.08-0.4 wt %, more preferably of 0.10-0.3 wt % (based on the overall weight of the polymer composition). In any case, the amount of stabilizer, for example in form of an anti-oxidant agent is more than 500 ppm, preferably more than 800 ppm, more preferably more than 1000 ppm, such as 1500 ppm.

In a some non-limiting embodiments, the polyolefin composition has an impact strength (IS0179-1, Charpy 1eA+23′C) of at least 30 kJ/m², preferably of at least 33 kJ/m², more preferably at least 35 kJ/m², still more preferably of at least 38 kJ/m², for example in a range of 25 to 50 kJ/m², more preferably in a range of 30 to 40 kJ/m², even more preferably in a range of 33 to 39 kJ/m².

In case of a polyolefin composition comprising 50-55 wt % polyethylene recyclate the impact strength is in a range of 30 to 40 kJ/m², more preferably in a range of 33 to 38 kJ/m².

The polyolefin composition has a melt flow rate MFR₅ (5 kg, 190′C, measured according to ISO 1133) of at least 0.8 g/10 min, preferably of at least 0.85 g/10 min, more preferably of at least 0.9 g/10 min, for example in the range of 0.8 to 2.0 g/10 min, preferably 0.85 to 1.5 g/10 min, more preferably 0.9 to 1.2 g/10 min.

The polyolefin composition has a melt flow rate MFR₂ (2.16 kg, 190° C., measured according to ISO 1133) of at least 0.1 g/10 min, preferably of at least 0.15 g/10 min, more preferably of at least 0.2 g/10 min, for example in the range of 0.1 to 0.8 g/10 min, preferably 0.15 to 0.5 g/10 min, more preferably 0.2 to 0.3 g/10 min.

In some non-limiting embodiments, the present polyolefin composition has a Young's modulus of 800-950 MPa, preferably of 850-900 MPa, more preferably of 870-880 MPa; a Yield strength of 20-30 MPa, preferably of 23-26 MPa and/or a strain-at-break of 50-110%, preferably of 60-105%, such as 60% or 103%.

### Polyethylene Virgin Polymers

The present polyolefin composition comprises 20-65 wt %, preferably 30-60 wt %, more preferably 35-55 wt %, even more preferably 40-50 wt % (based on the total weight of the polyolefin composition) of the at least one high density polyethylene with a melt flow rate MFR₅ (190° C., 5 kg, measured according to ISO 1133) of at least 0.8 g/10 min; In some non-limiting embodiments, the at least one high density polyethylene has a weight average molecular weight Mw (determined by GPC) from about 110,000 g/mol to about 280,000 g/mol. In some non-limiting embodiments, the at least one high density polyethylene has a weight average molecular weight Mw (determined by GPC) of greater than about 110,000 g/mol to less than about 260,000 g/mol. In some non-limiting embodiments, the at least one high density polyethylene has a weight average molecular weight Mw (determined by GPC) from about 125,000 g/mol to about 240,000 g/mol, or from about 135,000 g/mol to 220,000 g/mol.

In some non-limiting embodiments, the at least one high density polyethylene has density of at least 900 kg/m³, preferably of at least 950 kg/m³ (according to ISO 1183-1), for example in the range of 930-970 kg/m³, preferably of 940-960 kg/m³, more preferably of 950-960 kg/m³.

In some non-limiting embodiments, the at least one high density polyethylene has a melt flow rate MFR₅ (5 kg, 190° C., measured according to ISO 1133) of at least 0.9 g/10 min, preferably of at least 1 g/10 min, for example in the range of 0.8 to 2.0 g/10 min, preferably 0.85 to 1.5 g/10 min, more preferably 0.9 to 1.2 g/10 min.

In some non-limiting embodiments, the at least one high density polyethylene has a melt flow rate MFR₂ (2.16 kg, 190° C., measured according to ISO 1133) of at least 0.1 g/10 min, preferably of at least 0.15 g/10 min, more preferably of at least 0.2 g/10 min, for example in the range of 0.1 to 0.8 g/10 min, preferably 0.15 to 0.5 g/10 min, more preferably 0.2 to 0.3 g/10 min.

In some non-limiting embodiments, the at least one high density polyethylene has a B10 ESCR above 800 hours (measured according to ASTM D1693 at condition B in 10% Igepal at 50° C.), preferably above 1000 hours, more preferably above 1500 hours, even more preferably above 2000 hours, for example in a range of 600 to 10,000 hours, preferably 800 to 8000 hours, more preferably 1000 to 5000 hours.

In some non-limiting embodiments, the at least one high density polyethylene has an impact strength (IS0179-1, Charpy 1eA+23° C.) of at least 30 kJ/m², preferably of at least 35 kJ/m², more preferably at least 40 kJ/m², still more preferably of at least 45 kJ/m², for example in a range of 30 to 50 kJ/m², for example in a range of 33 to 48 kJ/m², or in a range of 35 to 47 kJ/m².

In some non-limiting embodiments, bimodal polyethylene is used in the present polyolefin composition as the at least one virgin, high density polyethylene. The properties and features of the virgin bimodal polyethylene that may be used in the present polyolefin composition are described in the following.

The term “bimodal” means herein that the polymer consists of two polyethylene fractions, which have been produced under different polymerization conditions resulting in different (weight average) molecular weights and molecular weight distributions for the fractions. The form of the molecular weight distribution curve, i.e., the appearance of the graph of the polymer weight fraction as a function of its molecular weight, of a multimodal polymer will show two or more maxima or is typically distinctly broadened in comparison with the curves for the individual fractions.

The bimodal polyethylene comprises a polyethylene homopolymer and a polyethylene copolymer.

By the term “ethylene homopolymer” it is meant a polymer which is formed of essentially only ethylene monomer units, i.e., of 99.9 wt % ethylene or more. It will be appreciated that minor traces of other monomers may be present due to industrial ethylene containing trace amounts of other monomers.

By the term “ethylene copolymer” it is meant that the copolymer comprises both ethylene and at least one alpha-olefin comonomer. The comonomer is one or more suitable alpha olefin such as but not limited to 1-butene, 1-hexene, 1-octene and/or the like, with 1-butene being preferred.

### Bimodal Polyethylene (BPE-1):

The at least one bimodal polyethylene (BPE-1) comprises a polyethylene homopolymer and a polyethylene copolymer. The copolymer is based on ethylene and 1-butene as comonomer. Preferably the content of 1-butene (determined by NMR) in the polymer is in the range from 0.1 to 2 wt % based on the total weight of the polymer, preferably 0.2 to 1.2 wt % and more preferably 0.3 to 1 wt %, such as 0.5 wt %.

It has a melt flow rate MFR₅ (190° C., 5 kg, measured according to ISO 1133) in the range of 1.0 to 1.5 g/10 min, preferably of 1.1 to 1.3 g/10 min, more preferably of 1.1 to 1.2 g/10 min.

The melt flow rate MFR₂ (190° C., 2.16 kg, measured according to ISO 1133) is in the range of 0.15 to 0.5 g/10 min, preferably of 0.2 to 0.4 g/10 min, more preferably of 0.25 to 0.3 g/10 min.

It has a B10 ESCR above 800 hours (measured according to ASTM D1693 at condition B in 10% Igepal at 50° C. ASTM D1693), preferably above 1000 hours, more preferably above 1500 hours, even more preferably above 2000 hours, for example in a range of 800 to 10,000 hours, preferably 1000 to 8000 hours, more preferably 1500 to 5000 hours.

The density is about 940-970 kg/m³, preferably 950-960 kg/m³.

It has an impact strength (ISO179-1, Charpy 1eA+23° C.) of at least 30 kJ/m², preferably of at least 35 kJ/m², for example in a range of 30 to 40 kJ/m², for example in a range of 33 to 37 kJ/m², such as 35 kJ/m².

It has a Young's modulus of 900-1000 MPa, preferably of 950-980 MPa, more preferably of 970-980 MPa; a Yield strength of 20-30 MPa, preferably of 23-26 MPa and/or a strain-at-break of 25-50%, preferably of 30-40%.

### Bimodal Polyethylene (BPE-2):

The at least one bimodal polyethylene (BPE-2) comprises a polyethylene homopolymer and a polyethylene copolymer. The copolymer is based on ethylene and 1-butene as comonomer. Preferably the content of 1-butene (determined by NMR) in the polymer is in the range from 0.1 to 2 wt % based on the total weight of the polymer, preferably 0.2 to 1.2 wt % and more preferably 0.3 to 1 wt %, such as 0.5 wt %.

It has a melt flow rate MFR₅ (190° C., 5 kg, measured according to ISO 1133) in the range of 0.5 to 1.5 g/10 min, preferably of 0.7 to 1.2 g/10 min, more preferably of 0.8 to 1.0 g/10 min, such as 0.9 g/10 min.

The melt flow rate MFR₂ (190° C., 2.16 kg, measured according to ISO 1133) is in the range of 0.1 to 0.5 g/10 min, preferably of 0.15 to 0.4 g/10 min, more preferably of 0.2 to 0.3 g/10 min.

It has a B10 ESCR above 600 hours (measured according to ASTM D1693 at condition B in 10% Igepal at 50° C. ASTM D1693), preferably above 1000 hours, more preferably above 1500 hours, even more preferably above 2000 hours, for example in a range of 600 to 8,000 hours, preferably 1000 to 6000 hours, more preferably 1500 to 5000 hours.

The density is about 940-970 kg/m³, preferably 950-960 kg/m³.

It has an impact strength (ISO179-1, Charpy 1eA+23° C.) of at least 35 kJ/m², preferably of at least 40 kJ/m², for example in a range of 35 and 55 kJ/m², more preferably in a range of 40 and 50 kJ/m², such as 46 kJ/m².

It has a Young's modulus of 900-1200 MPa, preferably of 950-1100 MPa, more preferably of 1000-1050 MPa; a Yield strength of 25-35 MPa, preferably of 28-30 MPa and/or a strain-at-break of 20-40%, preferably of 22-25%.

### Blend of Recycled Material

The present polyolefin composition may comprise 35-80 wt %, preferably 40-70 wt %, more preferably 45-65 wt %, even more preferably 50-60 wt %, such as 55 wt % (based on the total 35 weight of the polyolefin composition) of a polyethylene enriched blend of recycled plastic material comprising polyethylene and polypropylene, which is recovered from a waste plastic material derived from post-consumer and/or post-industrial waste, with a melt flow rate MFR₅ (190° C., 5 kg, measured according to ISO 1133) of at least 0.8 g/10 min.

The blend is obtained from a recycled waste stream. The blend can be either recycled post-consumer waste or post-industrial waste, such as for example from the automobile industry, or alternatively, a combination of both. It is preferred that blend consists of recycled post-consumer waste and/or post-industrial waste.

Preferably, the polyethylene rich recycled material is obtained from recycled waste by means of plastic recycling processes known in the art. Such recyclates are commercially available, e.g., from Corepla (Italian Consortium for the collection, recovery, recycling of packaging plastic wastes), Resource Plastics Corp. (Brampton, ON), Kruschitz GmbH, Plastics and Recycling (AT), Vogt Plastik GmbH (DE), Mtm Plastics GmbH (DE) etc. Non-exhaustive examples of polyethylene rich recycled materials comprise: PURPOLEN PE (Mtm Plastics GmbH), food grade rHDPE (BIFFA PLC) and/or a range of polyethylene rich materials, such as e.g. HD-LM02041 from PLASgran Ltd. It is considered that the present disclosure could be applicable to a broad range of recycled polyethylene-rich materials or materials or compositions having a high content of recycled polyethylene. The polyethylene-rich recycled material may be in the form of granules. It may be obtained from domestic waste streams (i.e., it is a product of domestic recycling) for example the “yellow bag” recycling system, which operates in some parts of Germany.

In some non-limiting embodiments, the polyethylene enriched blend of recycled plastic material comprises
a C2 fraction in an amount of above 97.0 wt %, preferably above 98.0 wt %, more preferably above 99.0 wt %, for example in a range of 97.0 to 99.5 wt %, preferably in a range of 97.5 to 99.0 wt % as measured by NMR of the d2-tetrachloroethylene soluble fraction, and
a continuous C3 fraction in an amount of below 3.0 wt.-%, preferably below 2.5 wt %. more preferably below 1.5% wt.-%, even more preferably below 1.0 wt.-%, for example in the range from 0 (not determinable) to 3.0 wt %, preferably 0.1 to 2.0 wt %, more preferably 0.1 to 1.5 wt %, even more preferably 0.1 to 1.0 wt %, and still more preferably 0.1 to 0.5 wt % as measured by NMR of the d2-tetrachloroethylene soluble fraction.

In some non-limiting embodiments, the polyethylene enriched blend of recycled plastic has a content of C4 of less than 1.0 wt %, preferably less than 0.8 wt %, more preferably of less than 0.5 wt % (as measured by NMR of the d2-tetrachloroethylene soluble fraction), a content of C6 of less than 1.0 wt %, preferably less than 0.8 wt %, more preferably of less than 0.5 wt % (as measured by NMR of the d2-tetrachloroethylene soluble fraction), and a not determinable content of LDPE (as measured by NMR of the d2-tetrachloroethylene soluble fraction).

The polyethylene fraction of the recycled material can comprise recycled high-density polyethylene (rHDPE), recycled medium-density polyethylene (rMDPE), recycled low-density polyethylene (rLDPE), recycled linear low density polyethylene (rLLDPE) and/or the mixtures thereof. In a some non-limiting embodiments, the recycled material is high density PE with an average density of greater than 0.940 g/cm³, preferably greater than 0.945 g/cm³, most preferably greater than 0.950 g/cm³.

In some non-limiting embodiments, the polyethylene enriched blend of recycled plastic material comprises further components selected from the group comprising polystyrene, stabilizers, polyamide, talc, chalk, paper, wood, metal, limonene, fatty acid and/or mixtures thereof.

Due to the recycling origin, the blend may comprise: organic fillers, and/or inorganic fillers, and/or additives in amounts of up to 10 wt %, preferably up to 3 wt % with respect to the weight of the blend.

As stated above, the recyclate blend may comprise one or more further components, selected from:
up to 3.0 wt % stabilizers, preferably up to 2.0 wt % stabilizers,
up to 4.0 wt % polyamide, preferably up to 2.0 wt % polyamide,
up to 3.0 wt % talc, preferably up to 1.0 wt % talc,
up to 3.0 wt % chalk, preferably up to 1.0 wt % chalk,
up to 1.0 wt % paper, preferably up to 0.5 wt % paper,
up to 1.0 wt % wood, preferably up to 0.5 wt % wood, and
up to 0.5 wt % metal, preferably up to 0.1 wt % metal,
   based on the overall weight of blend (A).

According to some non-limiting embodiments, the polyethylene enriched blend of recycled plastic material has an impact strength (IS0179-1, Charpy 1eA+23′C) of at least 25 kJ/m², more preferably at least 28 kJ/m², for example in a range of 25 to 40 kJ/m², more preferably in a range of 25 to 35 kJ/m², even more preferably in a range of 25 to 30 kJ/m².

According to some non-limiting embodiments, the polyethylene enriched blend of recycled plastic material has a melt flow rate MFR₅ (5 kg, 190° C., measured according to ISO 1133) of at least 0.8 g/10 min, preferably of at least 1 g/10 min, for example in the range of 0.8 to 2.0 g/10 min, preferably of 0.8 to 1.5 g/10 min.

The melt flow rate MFR₂ (2.16 kg, 190′C, measured according to ISO 1133) of the polyethylene enriched blend of recycled plastic material is at least 0.1 g/10 min, preferably of at least 0.15 g/10 min, more preferably of at least 0.2 g/10 min, but always not more than 0.5 g/10 min; for example in the range of 0.1 to 0.5 g/10 min, preferably 0.2 to 0.45 g/10 min.

The polyethylene enriched blend of recycled plastic has a Young's modulus of 800-1000 MPa, preferably of 840-900 MPa; a Yield strength of 20-30 MPa, preferably of 24-26 MPa and/or a strain-at-break of 30-140%, such as 35% or 134%.

In some non-limiting embodiments, the recyclate blend has a density of 920-980 kg/m³, preferably of 950-960 kg/m³.

In the following, more specific non-limiting embodiments of the polymer composition in accordance with the present disclosure are described.

In some non-limiting embodiments, a polyolefin composition is provided that comprises:
a) 40-50 wt % (based on the total weight of the polyolefin composition) of at least one high density polyethylene (BPE-1) comprising at least one polyethylene homopolymer and at least one polyethylene copolymer with a melt flow rate MFR₅ (190′C, 5 kg, measured according to ISO 1133) of at least 1.0 g/10 min and a B10 ESCR above 800 hours (measured according to ASTM D1693 at condition B in 10% Igepal at 50° C.),
b) 50-60 wt % (based on the total weight of the polyolefin composition) of a polyethylene enriched blend of recycled plastic material (Blend A1), with
   a C2 fraction in an amount of above 98.0 wt. %, for example in a range of 98.5 to 99.5 wt %, as measured by NMR of the d2-tetrachloroethylene soluble fraction, and
   a continuous C3 fraction in an amount of ≥1.5 wt.-%, for example in the range from 0.1 to 1.5 wt %, as measured by NMR of the d2-tetrachloroethylene soluble fraction;
c) optionally further additives, wherein the sum of all ingredients always adds up to 100 wt %.
   wherein the polyolefin composition has an impact strength (IS0179-1, Charpy 1eA+23° C.) of at least 35 kJ/m².

In a non-limiting embodiment a polyolefin composition is provided that comprises
a) 40-50 wt % (based on the total weight of the polyolefin composition) of at least one high density polyethylene (BPE-2) comprising at least one polyethylene homopolymer and at least one polyethylene copolymer with a melt flow rate MFR₅ (190° C., 5 kg, measured according to ISO 1133) of at least 0.8 g/10 min and a B10 ESCR above 600 hours (measured according to ASTM D1693 at condition B in 10% Igepal at 50° C.);
b) 50-60 wt % (based on the total weight of the polyolefin composition) of a polyethylene enriched blend of recycled plastic material (Blend A2), with
   a C2 fraction in an amount of above 98.5 wt. %, for example in a range of 90.0 to 99.9 wt %, as measured by NMR of the d2-tetrachloroethylene soluble fraction, and
   a continuous C3 fraction in an amount of below 1.0 wt.-%, for example in the range from 0.1 to 0.5 wt %, as measured by NMR of the d2-tetrachloroethylene soluble fraction;
c) optionally further additives, wherein the sum of all ingredients always adds up to 100 wt %.
   wherein the polyolefin composition has an impact strength (IS0179-1, Charpy 1eA+23° C.) of at least 30 kJ/m².

### Stabilizer

As mentioned above, the present polyolefin composition comprises at least one stabilizer, for example at least one anti-oxidant agent.

Examples of antioxidants which are commonly used in the art, are sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), 35 The at least one stabilizer may be present in the polyolefin composition in an amount of 0.05-0.5 wt %, preferably of 0.08-0.4 wt %, more preferably of 0.10-0.3 wt % (based on the overall weight of the polymer composition).

### Further Additives

In some non-limiting embodiments, the polyolefin composition may comprise further additives. Examples of additives for use in the composition are pigments or dyes (for example carbon black), anti-acids and/or anti-UVs, antistatic agents, nucleating agents and/or utilization agents (such as processing aid agents). Preferred additives are carbon black, at least one antioxidant and/or at least one UV stabilizer.

Generally, the amount of these additives is in the range of 0 to 5.0 wt %, preferably in the range of 0.01 to 3.0 wt %, more preferably from 0.01 to 2.0 wt % based on the weight of the total composition.

Anti-acids are also commonly known in the art. Examples are calcium stearates, sodium stearates, zinc stearates, magnesium and zinc oxides, synthetic hydrotalcite (e.g. SHT, CAS-No. 11097-59-9), lactates and lactylates, as well as calcium stearate (CAS No. 1592-23-0) and/or zinc stearate (CAS No. 557-05-1).

Common antiblocking agents are natural silica such as diatomaceous earth (such as CAS No. 60676-86-0 (SuperfFloss™), CAS-No. 60676-86-0 (SuperFloss E™), or CAS-No. 60676-86-0 (Celite 499™)), synthetic silica (such as CAS-No. 7631-86-9, CAS-No. 7631-86-9, CAS-No. 7631-86-9, CAS-No. 7631-86-9, CAS-No. 7631-86-9, CAS-No. 7631-86-9, CAS-No. 112926-00-8, CAS-No. 7631-86-9, or CAS-No. 7631-86-9), silicates (such as aluminium silicate (Kaolin) CAS-no. 1318-74-7, sodium aluminum silicate CAS-No. 1344-00-9, calcined kaolin CAS-No. 92704-41-1, aluminum silicate CAS-No. 1327-36-2, or calcium silicate CAS-No. 1344-95-2), synthetic zeolites (such as sodium calcium aluminosilicate hydrate CAS-No. 1344-01-0, CAS-No. 1344-01-0, and/or sodium calcium aluminosilicate, hydrate CAS-No. 1344-01-0).

Anti-UVs are, for example, Bis-(2,2,6,6-tetramethyl-4-piperidyl)-sebacate (CAS-No. 52829-07-9, Tinuvin 770); and/or 2-hydroxy-4-n-octoxy-benzophenone (CAS-No. 1843-05-6, Chimassorb 81). Preferred UV stabilizers may be low and/or high molecular weight UV stabilizers such as n-Hexadecyl-3,5-di-t-butyl-4-hydroxybenzoate, A mixture of esters of 2,2,6,6-tetramethyl-4-piperidinol and higher fatty acids (mainly stearic acid) and/or Poly((6-morpholino-s-triazine-2,4-diyl)(1,2,2,6,6-pentamethyl-4-piperidyl)imino)hexameth-ylene (1,2,2,6,6-pentamethyl-4-piperidyl)imino)).

It is appreciated that the present disclosure also refers to a process for producing the polyolefin compositions as defined herein. The process comprises the steps of:
Providing a mixture of
a) 20-65 wt % (based on the total weight of the polyolefin composition) of at least one high density polyethylene with a melt flow rate MFR₅ (190′C, 5 kg, measured according to ISO 1133) of at least 0.8 g/10 min;
b) 35-80 wt % (based on the total weight of the polyolefin composition) of a polyethylene enriched blend of recycled plastic material, which is recovered from a waste plastic material derived from post-consumer and/or post-industrial waste, with
   a C2 fraction in an amount of above 96.5 wt.-%, for example in a range of 96.5 to 99.9 wt %, as measured by NMR of the d2-tetrachloroethylene soluble fraction, and
   a continuous C3 fraction in an amount of below ≥3.5 wt.-%, for example in the range from 0.1 to 3.5 wt %, as measured by NMR of the d2-tetrachloroethylene soluble fraction;
c) optionally further additives, wherein the sum of all ingredients always adds up to 100 wt %,
melting the mixture in an extruder, and
optionally pelletizing the obtained polyolefin composition.

For the purposes of the present disclosure, any suitable melting and mixing means known in the art may be used for carrying out the mixing and melting.

However, the melting and mixing step preferably takes place in a mixer and/or blender, high or low shear mixer, high-speed blender, or a twin-screw extruder. Most preferably, the melting and mixing step takes place in a twin-screw extruder such as a co-rotating twin-screw extruder. Such twin-screw extruders are well known in the art and the skilled person will adapt the melting and mixing conditions (such as melting temperature, screw speed and the like) according to the process equipment.

The polyolefin composition according to the present disclosure can be used for a wide range of applications, for example in the manufacture of containers and bottles.

### DETAILED DESCRIPTION

The present disclosure is now explained in more detail with reference to the examples.

### Experimental Section

The following Examples are included to demonstrate certain aspects and non-limiting embodiments of the present disclosure as described in the claims. It should be appreciated by those of skill in the art, however, that the following description is illustrative only and should not be taken in any way as a restriction of the present disclosure.

### Test Methods

The following definitions of terms and determination methods apply for the above general description of the present disclosure as well as to the below examples unless otherwise defined.

### Production of Multipurpose Specimens (MPS) and Charpy Type 1 Specimen

All MPS and Charpy Type 1 bar specimens were produced via injection molding according to the conditions described in ISO 3167 (Plastics—Multipurpose test specimens), ISO 179-1(Plastics—Determination of Charpy impact properties—Part 1: Non-instrumented impact test) and ISO 17855-2 (Plastics—Polyethylene (PE) moulding and extrusion materials—Part 2: Preparation of test specimens and determination of properties) on an Engel Victory 60 (Engel, Austria). Specimens were conditioned at 23° C. and 50% relative humidity for at least three days. After conditioning, the MPS were used for tensile testing and the Type 1 bar specimen after notching for Charpy notched impact testing according to ISO 179-1 (see more information about the test later).

### Melt Flow Rate (MFR)

The MFR measurements were conducted at 190′C and with 5 kg on a Zwick/Roell Mflow melt flow indexer (ZwickRoell, Germany) according to ISO 1133-1 (Plastics—Determination of the melt mass-flow rate (MFR) and melt volume-flow rate (MVR) of thermoplastics—Part 1: Standard method). Cuts were made every 3 mm piston movement. The time between cuts was measured and each extrudate was weighted on an ABS 220-4 electronic balance (Kern & Sohn, Germany). The extrapolation to 10 minutes calculated the MFR in g/10 min for each cut. For each material, one measurement was conducted. Within one measurement, 6 cuts were made and used for the calculation of average values and standard deviations.

### Environmental Stress Cracking Resistance (ESCR)

Environmental stress cracking resistance was tested with the Bell test according to ASTM D 1693 with 10% Igepal at 50° C. according to the method B. The specimens used for testing were prepared by compression moulding according to ISO 17855-2. The compression moulded sheets had a thickness of 1.84 to 1.97 mm.

### Density

The density measurements were conducted according to ISO 1183-1 (Plastics—Methods for determining the density of non-cellular plastics—Part 1: Immersion method, liquid pycnometer method and titration method) with a Sartorius CPA 225D lab balance (Sartorius, German). Samples were cut from the sprue-sided shoulders of multi-purpose specimens (MPS). In the first step, the respective sample was weighed dry, measuring its mass in air (m_{S,A}). In the second step, the sample was immersed in deionized water and put below a buoyancy cage which was connected to the scale, enabling the measurement of the sample buoyancy (m_{S,IL}) without the need of a sinker. A wire was used to free the sample of air bubbles and the temperature of the immersion liquid was recorded for the calculation of its density (ρ_{IL}). The sample density was calculated according to following formula with measurement apparatus correction variables A and B:

$${ρ}_{s} = \frac{{m}_{S . A} * {ρ}_{IL}}{A * ( {m}_{S . A} - {m}_{S . IL} )} + B$$

For each material, five samples, each cut from an individual MPS, were used for the calculation of average values and standard deviations.

### Tensile Properties

The mechanical properties (Young's modulus, yield strength and strain at break) were examined with an universal testing machine Zwick AllroundLine Z020 (Zwick Roell, Germany) equipped with a multi-extensometer at 23° C. Test parameters and MPS were used according to ISO 527-1 (Plastics—Determination of tensile properties—Part 1: General principles) and ISO 527-2 (Part 2: Test conditions for moulding and extrusion plastics) with a traverse speed of 1 mm/min for Young's modulus determination until a strain of 0.25% and after that 50 mm/min until failure. Calculations of tensile modulus, yield stress and strain at break were done in accordance with ISO 527-1. Therefore, the tensile modulus was calculated as the slope of the stress/strain curve between 0.05% and 0.25% via regression, the yield stress was the stress at the first occurrence of strain increase without a stress increase, and the strain at break was the strain when the specimen broke. The strain was recorded via a multi-extensometer until yield. From there, the nominal strain was calculated via Method B according to ISO 527-1 with the aid of the crosshead displacement. This process is integrated and automated in the used testing software TestXpert III (v1.61, ZwickRoell, Germany). For each material five MPS were tested for the calculation of average values and standard deviations.

### Charpy Notched Impact Strength

Impact tests were conducted according to ISO 179-1 (Plastics—Determination of Charpy impact properties—Part 1: Non-instrumented impact test) on a Zwick/Roell HIT25P pendulum impact tester (ZwickRoell, Germany) with injection molded Type 1 bar specimens (see information above). After pretests to determine the suitable pendulum size, either a 5 Joule or a 2 Joule pendulum, in each case the pendulum with the highest available energy that still conforms to the requirements was chosen for testing the respective material. Notches were produced with a Leica RM2265 microtome (Leica, Germany) and measured with an Mitutoyo Absolute 547-313 digital thickness gauge with a wedge tip. Test conditions were 23° C. with edgewise notched specimens with 0.25 mm notch-radius (1eA). For each material ten specimens were tested for the calculation of average values and standard deviations.

### Oxidation Induction Temperature

A differential thermal analysis (DTA) instrument of the type DSC 4000 (PerkinElmer, USA) was utilized to characterize the oxidation induction temperature (dynamic OIT) according to ISO 11357-6 (Plastics—Differential scanning calorimetry (DSC)—Part 6: Determination of oxidation induction time (isothermal OIT) and oxidation induction temperature (dynamic OIT)).

Samples were cut from shoulders of injection molded MPS and encapsuled in perforated aluminum pans. The average sample weight was around 5 mg. A single heating step between 23° C. and 300° C. was performed with a heating rate of 10 K/min with synthetic air as purge gas and a flow rate of 20 ml/min. The point of intersect of the slope before oxidation and during oxidation gives the onset of oxidation or the oxidation induction temperature in ° C. For each material, five samples, each cut from an individual MPS, were used for the calculation of average values and standard deviations.

### Gel Permeation Chromatography (GPC)

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔV, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3×Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$$\begin{matrix}{K}_{P S} = 19 \times {10}^{- 3} mL / g , {α}_{P S} = 0.655 \\ {K}_{P E} = 39 \times {10}^{- 3} mL / g , {α}_{P E} = 0.725 \\ {K}_{P P} = 19 \times {10}^{- 3} mL / g , {α}_{P P} = 0.725\end{matrix}$$

A third order polynomial fit was used to fit the calibration data.

All samples were prepared in the concentration range of 0.5-1 mg/ml and dissolved at 160° C. for 3 hours for PE under continuous gentle shaking.

### NMR Measurement

### NMR Measurement of Polyethylene Virgin Polymers

Quantitative nuclear-magnetic resonance (NMR) spectroscopy was used to quantify the comonomer content of the virgin polymers.

Quantitative ¹³C{¹H} NMR spectra recorded in the molten-state using a Bruker Avance 111 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification (Klimke, K., Parkinson, M., Piel, C., Kaminsky, W., Spiess, H. W., Wilhelm, M., Macromol. Chem. Phys. 2006; 207:382., Parkinson, M., Klimke, K., Spiess, H. W., Wilhelm, M., Macromol. Chem. Phys. 2007; 208:2128., Castignolles, P., Graf, R., Parkinson, M., Wilhelm, M., Gaborieau, M., Polymer 50 (2009) 2373). Standard single-pulse excitation was employed utilising the transient NOE at short recycle delays of 3s (Pollard, M., Klimke, K., Graf, R., Spiess, H. W., Wilhelm, M., Sperber, O., Piel, C., Kaminsky, W., Macromolecules 2004; 37:813., Klimke, K., Parkinson, M., Piel, C., Kaminsky, W., Spiess, H. W., Wilhelm, M., Macromol. Chem. Phys. 2006; 207:382.) and the RS-HEPT decoupling scheme (Filip, X., Tripon, C., Filip, C., J. Mag. Resn. 2005,176, 239, Griffin, J. M., Tripon, C., Samoson, A., Filip, C., and Brown, S. P., Mag. Res. in Chem. 2007 45, S1, S198). A total of 1024 (1k) transients were acquired per spectrum.

Quantitative ¹³C{¹H} NMR spectra were processed, integrated and quantitative properties determined using custom spectral analysis automation programs. All chemical shifts are internally referenced to the bulk methylene signal (δ+) at 30.00 ppm (J. Randall, Macromol. Sci., Rev. Macromol. Chem. Phys. 1989, C29, 201).

Characteristic signals corresponding to the incorporation of 1-butene were observed (J. Randall, Macromol. Sci., Rev. Macromol. Chem. Phys. 1989, C29, 201.) and all contents calculated with respect to all other monomers present in the polymer with the limit of quantification being 0.2 mol % of butene.

Characteristic signals resulting from isolated 1-butene incorporation i.e. EEBEE comonomer sequences, were observed. Isolated 1-butene incorporation was quantified using the integral of the signal at 39.8 ppm assigned to the *B2 sites, accounting for the number of reporting sites per comonomer:

$$B = {I}_{* B 2}$$

When characteristic signals resulting from consecutive 1-butene incorporation i.e. EBBE comonomer sequences were observed, such consecutive 1-butene incorporation was quantified using the integral of the signal at 39.3 ppm assigned to the aaB2B2 sites accounting for the number of reporting sites per comonomer:

$$BB = 2 * I {αα}_{B 2 B 2}$$

When characteristic signals resulting from non consecutive 1-butene incorporation i.e. EBEBE comonomer sequences were also observed, such non-consecutive 1-butene incorporation was quantified using the integral of the signal at 24.7 ppm assigned to the PsB2B2 sites accounting for the number of reporting sites per comonomer:

$$BEB = 2 * I {ββ}_{B 2 B 2}$$

Due to the overlap of the *B2 and *βB2B2 sites of isolated (EEBEE) and non-consecutively incorporated (EBEBE) 1-butene respectively the total amount of isolated 1-butene incorporation is corrected based on the amount of non-consecutive 1-butene present:

$$B = {I}_{* B 2} - 2 * I {ββ}_{B 2 B 2}$$

With no other signals indicative of other comonomer sequences, i.e. butene chain initiation, observed the total 1-butene comonomer content was calculated based solely on the amount of isolated (EEBEE), consecutive (EBBE) and non-consecutive (EBEBE) 1-butene comonomer sequences:

$${B}_{t otal} = B + B B + B E B$$

Characteristic signals resulting from saturated end-groups were observed. The content of such saturated end-groups was quantified using the average of the integral of the signals at 22.8 and 32.2 ppm assigned to the 2s and 3s sites respectively:

$$S = ( 1 / 2 ) * ( {I}_{2 S} + {I}_{3 S} )$$

The relative content of ethylene was quantified using the integral of the bulk methylene (δ+) signals at 30.00 ppm:

$$E = ( 1 / 2 ) * I {δ}_{+}$$

The total ethylene comonomer content was calculated based the buk methylene signals and accounting for ethylene units present in other observed comonomer sequences or end-groups:

$${E}_{t otal} = E + ( 5 / 2 ) * B + ( 7 / 2 ) * BB + ( 9 / 2 ) * BEB + ( 3 / 2 ) * S$$

The total mole fraction of 1-butene in the polymer was then calculated as:

$$f B = {B}_{total} / ( {E}_{total} + {B}_{total} )$$

The total comonomer incorporation of 1-butene in mole percent was calculated from the mole fraction in the usual manner:

$$B [ mol \% ] = 100 * fB$$

The total comonomer incorporation of 1-butene in weight percent was calculated from the mole fraction in the standard manner:

$$B [ wt \% ] = 100 * ( fB * 56.11 ) / ( ( fB * 56.11 ) + ( ( 1 - fB ) * 28. 05 ) )$$

### NMR Measurement of Recyclate

Quantification of C2 rich fraction, PP (continuous C3), LDPE and polyethylene short chain branches in polyethylene based recyclates.

Quantitative ¹³C{¹H} NMR spectra were recorded in the solution-state using a Bruker AVNEO 400 MHz NMR spectrometer operating at 400.15 and 100.62 MHz for ¹H and ¹³C respectively. All spectra were recorded using a ¹³C optimised 10 mm extended temperature probehead at 125′C using nitrogen gas for all pneumatics. Approximately 200 mg of material was dissolved in approximately 3 ml of 1,2-tetrachloroethane-d₂ (TCE-d₂) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. Standard single-pulse excitation was employed without NOE, using an optimised tip angle, 1 s recycle delay and a bi-level WALTZ16 decoupling scheme (zhou07,busico07). A total of 6144 (6 k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3s 32.2 ppm) were observed. If one or the other structural element is not observable it is excluded from the equations. The intensity of the combined ethylene backbone methine carbons (Iddg) containing the polyethylene backbone carbons (dd 30.0 ppm), γ-carbons (g 29.6 ppm) the 4s and the threeB4 carbon (to be compensated for later on) is taken between 30.9 ppm and 29.3 ppm excluding the Tββ from polypropylene. The amount of C2 related carbons was quantified using all mentioned signals according to the following equation:

$${fC}_{C 2 total} = ( Iddg - ItwoB 4 ) + ( IstartB 1 * 6 ) + ( IstarB 2 * 7 ) + ( ItwoB 4 * 9 ) + ( IthreeB 5 * 10 ) + ( ( IstarB 4 plus - ItwoB 4 - IthreeB 5 ) * 7 ) + ( I 3 s * 3 )$$

When characteristic signals corresponding to the presence of polypropylene (PP, continuous C3)) were observed at 46.7 ppm, 29.0 ppm and 22.0 ppm the amount of PP related carbons was quantified using the integral of Sαα at 46.6 ppm:

$$f {C}_{P P} = Is αα * 3$$

The weight percent of the C2 fraction and the polypropylene can be quantified according following equations:

$$w {t}_{C 2 fraction} = {fC}_{C 2 total} * 100 / ( {fC}_{C 2 total} + {fC}_{P P} )$$

$$w {t}_{P P} = f {C}_{PP} * 100 / ( {fC}_{C 2 total} + {fC}_{P P} )$$

Characteristic signals corresponding to various short chain branches were observed and their weight percentages quantified as the related branch would be an alpha-olefin, starting by quantifying the weight fraction of each:

$$f w t C 2 = {fC}_{C 2 total} - ( ( IstarB 1 * 3 ) - ( IstarB 2 * 4 ) - ( ItwoB 4 * 6 ) - ( IthreeB 5 * 7 )$$

$$fwtC 3 ( isolated C 3 ) = IstarB 1 * 3$$

$$fwtC 4 = IstarB 2 * 4$$

$$fwtC 6 = ItwoB 4 * 6$$

$$fwtC 7 = IthreeB 5 * 7$$

$$fsu {m}_{wt \%} = f wtC 2 + f wtC 3 + f wtC 4 + f wtC 6 + f wtC 7$$

$$wtC 7 = fwtC 7 * 100 / {fsum}_{wt \%}$$

Normalisation of all weight fractions leads to the amount of weight percent for all related branches:

$$f s u {m}_{wt \% total} = fwtC 2 + f wtC 3 + f wtC 4 + f wtC 6 + f wtC 7 + f {C}_{P P}$$

$$wtC 2 total = fwtC 2 * 100 / {fsum}_{wt \% total}$$

$$wtC 3 total = fwtC 3 * 100 / {fsum}_{wt \% total}$$

$$wtC 4 total = fwtC 4 * 100 / {fsum}_{wt \% total}$$

$$wtC 6 total = fwtC 6 * 100 / {fsum}_{wt \% total}$$

$$wtC 7 total = fwtC 7 * 100 / {fsum}_{wt \% total}$$

The content of LDPE can be estimated assuming the B5 branch, which only arises from ethylene being polymerised under high pressure process, being almost constant in LDPE. We found the average amount of B5 if quantified as C7 at 1.46 wt %. With this assumption it is possible to estimate the LDPE content within certain ranges (approximately between 15 wt % (=LOQ) and 90 wt %), which are in terms of LOQ depending on the SNR ratio of the threeB5 signal:

$$wt \% LDPE ( in total PO ) = wt C 7 total * 100 / 1.46$$

$$wt \% LDPE ( in C 2 rich fraction ) = wt C 7 * 100 / 1.46$$

Different blends of recycled material were used. The blends are characterized by the following properties:

### Blend A1

MFR₅ 0.8-0.83 g/10 min, MFR₂ 0.25-0.28 g/10 min, density 0.95 kg/m³;, Young's modulus 900 MPa, yield strength 25.6 MPa, strain at break 35.4%; impact strength (notched charpy test 23° C.) 26-27 KJ/m², C2 total: 98.7 wt %; continuous C3 content 0.9 wt %

### Blend A2

MFR₅ 1.4-1.5 g/10 min, MFR₂ 0.45-0.5 g/10 min, density 0.968 kg/m³; Young's modulus 840 MPa, yield strength 24.0 MPa, strain at break 134.3%; impact strength (notched charpy test 23° C.) 28-29 KJ/m², C2 total: 99.0 wt %; continuous C3 content 0.3 wt %

### Blend A3: Comparative Example

MFR₅ 1.2-1.3 g/10 min, MFR₂ 0.4-0.43 g/10 min, density 0.95 kg/m³; PE enthalpy 177.66 J/g, PE Tm 131.91′C, Youngs modulus 899 MPa, yield strength 24.7 MPa, strain at break 49.2%; impact strength (notched charpy test 23° C.) 23-24 KJ/m², C2 total: 96.1 wt %; continuous C3 content 3.7 wt %

Virgin Polymers used are Bimodal Polyethylene BPE-1 and Bimodal Polyethylene BPE-2. Both were described above.

In following Table 1 several examples (comparative-CE; inventive-IE) are summarized. The blends of virgin polymer and recycled materials were produced on a twin-screw extruder. Table 1 shows the properties of the polyolefin composition according to the present disclosure, such as melt flow rate, modulus, and charpy notched impact strength.

Table 1 refers to polyolefin compositions comprising:
Comparative Example (CE1): Bimodal Polyethylene BPE-1
Comparative Example (CE2): Bimodal Polyethylene BPE-2
Comparative Example (CE3): Bimodal Polyethylene BPE-2 and 30 wt % blend of recycled material (Blend A3);
Comparative Example (CE4): Bimodal Polyethylene BPE-2 and 30 wt % blend of recycled material (Blend A2);
Comparative Example (CE5): Bimodal Polyethylene BPE-2 and 50 wt % blend of recycled material (Blend A3);
Comparative Example (CE6): Bimodal Polyethylene BPE-2 and 55 wt % blend of recycled material (Blend A3)
Inventive Example (IE1): Bimodal Polyethylene BPE-1 and about 55 wt % blend of recycled material (Blend A1),
Inventive Example (IE2): Bimodal Polyethylene BPE-2 and about 55 wt % blend of recycled material (Blend A2),
Comparative Example (CE7): blend of recycled material (Blend A3)
Comparative Example (CE8): blend of recycled material (Blend A1),
Comparative Example (CE9): blend of recycled material (Blend A2),

The following additives were used: Antioxidants: AO1 (Irganox 1010), AO2 (Irgafos 168).

As can be seen in Table 1, at higher loadings of PE recyclates, the effect of high purity is more pronounced. With 30% of recyclate, the difference in impact strength of the compounds is not appreciable. In contrast, with >50% of recyclate, the compounds prepared with Blend A1 and Blend A2 (continuous C3 content<1.0 wt %) are shown to have considerably higher impact strength than the compounds prepared with Blend A3 (continuous C3 content of 3.7 wt %), even though the difference in impact strength among those recyclates is not pronounced.

TABLE 1

| | CE1 | CE2 | CE3 | CE4 | CE5 | CE6 | IE1 | IE2 | CE7 | CE8 | CE9 |
|---|---|---|---|---|---|---|---|---|---|---|---|
| BPE-1 | 100 | | | | — | — | 44.87 | | | | |
| BPE-2 | | 100 | 70.00 | 70.00 | 49.85 | 44.87 | — | 44.87 | | | |
| Blend A3 | | | 30.00 | | 49.85 | 54.84 | — | | 100 | | |
| Blend A1 | | | | | — | — | 54.84 | | | 100 | |
| Blend A2 | | | | 30.00 | | | | 54.84 | | | 100 |
| AO1 | | | | | 0.15 | 0.15 | 0.15 | 0.15 | | | |
| AO2 | | | | | 0.15 | 0.15 | 0.15 | 0.15 | | | |
| MFR₂ (190° C./2.16 kg) | 0.29 | 0.21 | 0.21 | 0.24 | 0.39 | 0.27 | 0.23 | 0.26 | 0.4 | 0.27 | 0.48 |
| [g/10 min] | | | | | | | | | | | |
| MFR₅ (190° C./5 kg) | 1.14 | 0.91 | 0.91 | 1.02 | 1.17 | 1.21 | 0.95 | 1.15 | 1.21 | 0.82 | 1.45 |
| [g/10 min] | | | | | | | | | | | |
| Density [kg/m³] | 955 | 956 | 960 | 961 | 968 | 961 | 957 | 964 | 967 | 955 | 967 |
| Charpy nIS [kJ/m²] | 35.9 | 46.6 | 37.7 | 36.4 | 23.2 | 21.6 | 38.1 | 33.1 | 23.5 | 26.8 | 28.6 |
| Young's Modulus [MPa] | 977 | 1020 | 953 | 962 | 943 | 954 | 871 | 888 | 899 | 900 | 840 |
| Yield Strength [MPa] | 25.2 | 28.7 | 25.8 | 26.2 | 25.6 | 25.6 | 24.1 | 24.6 | 24.7 | 25.6 | 24.0 |
| Strain-at-break [%] | 31.7 | 23.9 | 53.0 | 40.3 | 28.0 | 31.2 | 60.0 | 103.6 | 49.2 | 35.4 | 134.3 |
| Oxidation induction | 241.9 | 243.0 | 236.5 | 249.9 | 268.0 | 272.0 | 262.7 | 270.3 | 241.9 | 233.4 | 262.0 |
| temperature [° C.] | | | | | | | | | | | |
| B10 ESCR (hours) | >850 | >630 | | | | | | | | | |
| NMR C2total (wt %) | | | 98.0 | 99.8 | 97.0 | | | 99.8 | 96.1 | 98.7 | 99.0 |
| NMR C3total (isolated | | | n.d. | n.d. | n.d. | | n.d. | n.d. | n.d. | n.d. | n.d. |
| C3) (wt %) | | | | | | | | | | | |
| NMR C4total (wt %) | | | 0.2 | 0.2 | 0.2 | | n.d. | 0.2 | 0.1 | 0.3 | 0.4 |
| NMR C6total (wt %) | | | n.d. | n.d. | n.d. | | n.d. | n.d. | 0.1 | 0.2 | 0.3 |
| NMR C7total (wt %) | | | n.d. | n.d. | n.d. | | n.d. | n.d. | n.d. | n.d. | n.d. |
| NMR iPPtotal | | | 1.8 | n.d. | 2.8 | | n.d. | n.d. | 3.7 | 0.9 | 0.3 |
| (continuous C3) (wt %) | | | | | | | | | | | |
| NMR LDPE in C2 | | | n.d. | n.d. | n.d. | | n.d. | n.d. | n.d. | n.d. | n.d. |
| fraction (%) | | | | | | | | | | | |
| NMR LDPE in total PO | | | n.d. | n.d. | n.d. | | n.d. | n.d. | n.d. | n.d. | n.d. |
| (%) | | | | | | | | | | | |

n.d.: not determinable (not detectable or not quantifiable).

1. A polyolefin composition comprising
a) 20-65 wt % (based on the total weight of the polyolefin composition) of at least one high density polyethylene comprising at least one polyethylene homopolymer and at least one polyethylene-copolymer with a melt flow rate MFR₅ (190° C., 5 kg, measured according to ISO 1133) of at least 0.8 g/10 min and a B10 ESCR above 600 hours (measured according to ASTM D1693);
b) 35-80 wt % (based on the total weight of the polyolefin composition) of a polyethylene enriched blend of recycled plastic material, which is recovered from a waste plastic material derived from at least one of post-consumer and/or post-industrial waste, with
a C2 fraction in an amount of above 96.5 wt %, as measured by NMR of the d2-tetrachloroethylene soluble fraction, and
a continuous C3 fraction in an amount of ≤3.5 wt %, as measured by NMR of the d2-tetrachloroethylene soluble fraction;
c) optionally further additives, wherein the sum of all ingredients always adds up to 100 wt %.
wherein the polyolefin composition has
an impact strength−(ISO179-1, Charpy 1eA+23° C.) of at least 25 kJ/m²

2. The polyolefin composition according to claim 1, wherein it comprises
a) 30-60 wt % based on the total weight of the polyolefin composition) of the at least one high density polyethylene with a melt flow rate MFR₅ (190° C., 5 kg, measured according to ISO 1133) of at least 0.8 g/10 min and a B10 ESCR above 600 hours (measured according to ASTM D1693);
b) 40-70 wt %, based on the total weight of the polyolefin composition) of the polyethylene enriched blend of recycled plastic material, which is recovered from a waste plastic material derived from at least one of post-consumer and/or post-industrial waste, and
c) optionally further additives, wherein the sum of all ingredients always adds up to 100 wt %.

3. The polyolefin composition according to claim 1, wherein it comprises at least one stabilizer.

4. The polyolefin composition according to claim 1, having a melt flow rate MFR₅ (5 kg, 190° C., measured according to ISO 1133) of at least 0.8 g/10 min.

5. The polyolefin composition according to claim 1, having a melt flow rate MFR₂ (2.16 kg, 190° C., measured according to ISO 1133) of at least 0.1 g/10 min.

6. The polyolefin composition according to claim 1, having an impact strength (ISO179-1, Charpy 1eA+23° C.) of at least 30 kJ/m².

7. The polyolefin composition according to claim 1, wherein the at least one high density polyethylene has density of at least 900 kg/m³.

8. The polyolefin composition according claim 1, wherein the at least one high density polyethylene has a melt flow rate MFR₅ (5 kg, 190° C., measured according to ISO 1133) of at least 0.9 g/10 min.

9. The polyolefin composition according to claim 1, wherein the at least one high density polyethylene has a melt flow rate MFR₂ (2.16 kg, 190° C., measured according to ISO 1133) of at least 0.1 g/10 min.

10. The polyolefin composition according to claim 1, wherein the at least one high density polyethylene has a B10 ESCR above 800 hours (measured according to ASTM D1693).

11. The polyolefin composition according to claim 1, wherein the at least one high density polyethylene has an impact strength (IS0179-1, Charpy 1eA+23° C.) of at least 30 kJ/m².

12. The polyolefin composition according to claim 1, wherein that the polyethylene enriched blend of recycled plastic material has
a C2 fraction in an amount of above 97.0 wt %, as measured by NMR of the d2-tetrachloroethylene soluble fraction, and
a continuous C3 fraction in an amount of below 3.0 wt.-% as measured by NMR of the d2-tetrachloroethylene soluble fraction.

13. The polyolefin composition according to claim 1, wherein the polyethylene enriched blend of recycled plastic has a content of C4 of less than 1.0 wt % (as measured by NMR of the d2-tetrachloroethylene soluble fraction), a content of C6 of less than 1.0 wt % (as measured by NMR of the d2-tetrachloroethylene soluble fraction), and a not determinable content of LDPE (as measured by NMR of the d2-tetrachloroethylene soluble fraction).

14. The polyolefin composition according to claim 1, wherein the polyethylene enriched blend of recycled plastic material has an impact strength (ISO179-1, Charpy 1eA+23° C.) of at least 25 kJ/m².

15. The polyolefin composition according to claim 1, wherein the polyethylene enriched blend of recycled plastic material has a melt flow rate MFR₅ (5 kg, 190° C., measured according to ISO 1133) of at least 0.8 g/10 min.

16. The polyolefin composition according to claim 1, wherein the polyethylene enriched blend of recycled plastic material has a melt flow rate MFR₂ (2.16 kg, 190° C., measured according to ISO 1133) of at least 0.1 g/10 min.

17. (canceled)

18. A process for producing the polyolefin composition according to claim 1, wherein the process comprises the steps of
providing a mixture of
a) 20-65 wt % (based on the total weight of the polyolefin composition) of at least one high density polyethylene with a melt flow rate MFR₅ (190° C., 5 kg, measured according to ISO 1133) of at least 0.8 g/10 min and a B10 ESCR above 600 hours (measured according to ASTM D1693);
b) 35-80 wt % (based on the total weight of the polyolefin composition) of a polyethylene enriched blend of recycled plastic material, which is recovered from a waste plastic material derived from at least one of post-consumer and/or post-industrial waste, with
a C2 fraction in an amount of above 96.5 wt.-%, as measured by NMR of the d2-tetrachloroethylene soluble fraction, and
a continuous C3 fraction in an amount of ≤3.5 wt.-%, as measured by NMR of the d2-tetrachloroethylene soluble fraction;
c) optionally further additives, wherein the sum of all ingredients always adds up to 100 wt %.
melting the mixture in an extruder, and
optionally pelletizing the obtained polyolefin composition.

19. An article comprising the polyolefin composition according to claim 1.

20. The article according to claim 19, wherein it is a container or a bottle.
